(19) United States
(12) Patent Application Publication
(10) Pub. No.: US 2017/0120089 A1
(43) Pub. Date: May 4, 2017

(54) METHODS AND APPARATUS FOR FIRE SUPPRESSION SYSTEM FOR TRANSPORTABLE CONTAINER

(71) Applicant: Firetrace USA, LLC, Scottsdale, AZ (US)

(72) Inventors: Michael Fisher, Scottsdale, AZ (US); Justin Coldiron, Phoenix, AZ (US); William David Hoffman, III, Scottsdale, AZ (US); John Tagliaferri, Scottsdale, AZ (US)

(21) Appl. No.: 14/927,796

(22) Filed: Oct. 30, 2015

(51) Int. Cl. A62C 3/00; A62C 35/13; A62C 35/02

(52) U.S. Cl. CPC A62C 3/002; A62C 35/026; A62C 35/13; A62C 3/10

(57) ABSTRACT

A fire suppression system according to various aspects of the present technology is configured to deliver a fire suppressant material in response to a detected fire condition in a transportable container. In one embodiment, the fire suppression system comprises a detection system adapted to generate a detection signal when exposed to a fire condition that triggers a deployment valve to release a fire suppressant material into the transportable container. The fire suppression system is also be configured to be selectively disarmed to prevent actuation of the deployment valve in the event of an inadvertent signal generated by the detection system.

### BACKGROUND OF THE TECHNOLOGY

Fire suppression systems often comprise a detecting element, an electronic control board, and an extinguishing system. For example, the detecting element monitors an area for a condition associated with a fire. When the detecting element detects a condition associated with a fire, it sends a signal to the electronic control board. Then, the electronic control board typically sounds an alarm, and triggers the extinguishing system in the area monitored by the detecting element. Generally, electronically-based fire suppression systems are complex, require significant installation time, and require a constant source of electrical power. In addition, in the event of malfunction or loss of power, these systems may be susceptible to failure. Also, certain types of electronically-based fire suppression systems may not be particularly well-suited for use on portable structures, such as transportation or cargo containers used on aircraft and boats.

### SUMMARY OF THE TECHNOLOGY

A fire suppression system according to various aspects of the present technology is configured to deliver a fire suppressant material in response to a detected fire condition in a transportable container. In one embodiment, the fire suppression system comprises a detection system adapted to generate a detection signal when exposed to a fire condition that triggers a deployment valve to release a fire suppressant material into the transportable container. The fire suppression system is also be configured to be selectively disarmed to prevent actuation of the deployment valve in the event of an inadvertent signal generated by the detection system.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 is representatively illustrates a fire suppression system installed within a transportable container according to various aspects of the present technology;

FIG. 2A representatively illustrates a side view of the fire suppression system installed within an interior of the transportable container in accordance with an exemplary embodiment of the present technology;

FIG. 2B representatively illustrates a side view of the fire suppression system installed within an interior of the transportable container according to an alternative embodiment of the present technology;

FIG. 3 representatively illustrates a deployment valve in accordance with an exemplary embodiment of the present technology;

FIG. 4 representatively illustrates a perspective view of the deployment valve and a discharge system in accordance with an exemplary embodiment of the present technology;

FIG. 5 representatively illustrates a top view of the deployment valve and the discharge system in accordance with an exemplary embodiment of the present technology;

FIG. 6 representatively illustrates a cross-sectional view of the deployment valve across line 6-6 of FIG. 5 in accordance with an exemplary embodiment of the present technology;

FIG. 7 representatively illustrates a cross-sectional view of the deployment valve across line 7-7 of FIG. 5 in accordance with an exemplary embodiment of the present technology;

FIG. 8A representatively illustrates a detailed view of the deployment valve in a disarmed state in accordance with an exemplary embodiment of the present technology;

FIG. 8B representatively illustrates first and second pressure zones within the deployment valve in the disarmed state in accordance with an exemplary embodiment of the present technology

FIG. 9A representatively illustrates a detailed view of the deployment valve in an armed state in accordance with an exemplary embodiment of the present technology;

FIG. 9B representatively illustrates a detailed view of the deployment valve in an actuated state in accordance with an exemplary embodiment of the present technology;

FIG. 9C representatively illustrates a detailed view of the internal pressure distribution of the deployment valve in an armed state in accordance with an exemplary embodiment of the present technology;

FIG. 10 representatively illustrates an internal perspective view of the deployment valve in accordance with an exemplary embodiment of the present technology;

FIG. 11A representatively illustrates a siphon tube in accordance with an exemplary embodiment of the present technology;

FIG. 11B representatively illustrates a siphon tube in accordance with an alternative embodiment of the present technology;

FIG. 12 representatively illustrates a detection tube in accordance with an exemplary embodiment of the present technology;

FIG. 13 representatively illustrates a burst detection tube in accordance with an exemplary embodiment of the present technology;

FIG. 14 representatively illustrates a protective covering for the detection tube in accordance with an exemplary embodiment of the present technology;

FIG. 15 representatively illustrates a linear heat detector in accordance with an exemplary embodiment of the present technology;

FIG. 16 representatively illustrates a detailed view of the linear heat detector in accordance with an exemplary embodiment of the present technology;

FIG. 17A representatively illustrates a routed detection tube within a frame of the transportable container in accordance with an exemplary embodiment of the present technology; and

FIG. 17B representatively illustrates the routed detection tube with the walls and frame of the transportable container removed in accordance with an exemplary embodiment of the present technology;

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of hardware or software components configured to perform the specified functions and achieve the various results. For example, the present technology may employ various vessels, sensors, detectors, control materials, valves, and the like, which may carry out a variety of functions. In addition, the present technology may be practiced in conjunction with any number of hazards, and the system described is merely one exemplary application for the technology. Further, the present technology may employ any number of conventional techniques for delivering control materials, sensing hazard conditions, controlling valves, and the like.

Methods and apparatus for a pneumatically actuated fire suppression system for a transportable container according to various aspects of the present technology may operate in conjunction with any suitable mobile and/or stationary container device. Various representative implementations of the present technology may be applied to any system for suppressing fires or controlling other hazardous conditions, such as chemical spills. Certain representative implementations may include, for example, portable and/or non-portable containers, unit load devices for aircrafts, cargo containers, intermodal containers, and fixed storage units.

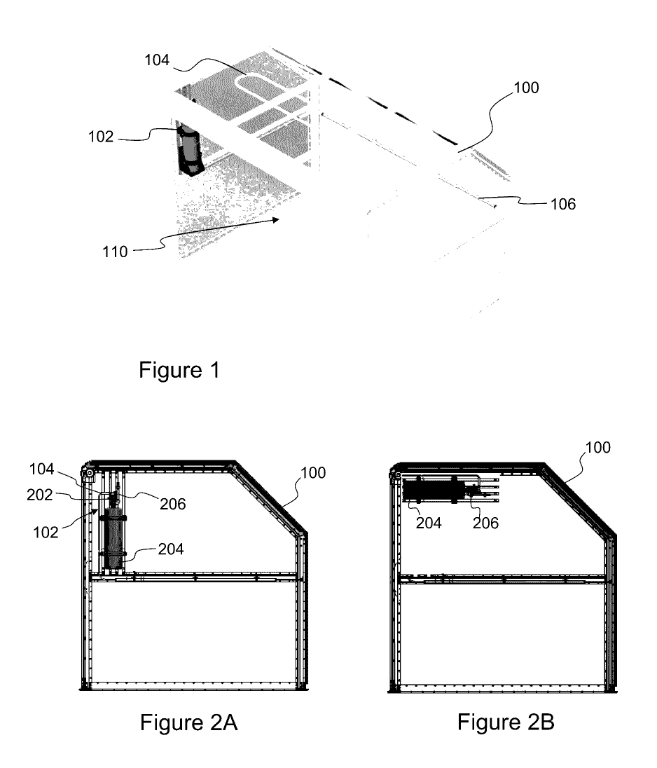

Referring now to FIG. 1, a pneumatically actuated fire suppression system for a transportable container 100 according to various aspects of the present technology may comprise a detection system 104 for detecting a fire condition and a suppression system 102 for providing a hazard control material, such as a fire suppressant, to an interior of the transportable container 100. The transportable container 100 may comprise any suitable box or cargo container such as, a unit load device for aircraft or an intermodal container for a cargo ship. The pneumatically actuated fire suppression system may further comprise a protective element 106 for protecting the detection system 104 from damage. The suppression system 102 and the detection system 104 may also be suitably configured to be coupled together within an interior of the transportable container 100.

Detection System

The detection system 104 generates a detection signal in response to a detected hazard condition. The detection system 104 may comprise any appropriate system for detecting one or more specific hazards and generating a corresponding detection signal, such as system for detecting smoke, heat, open flames, poisonous gas, radiation, and the like. For example, the detection system 104 may be adapted to detect a fire by sensing heat by any suitable method such as a discrete point heat detector or an ultraviolet or infrared sensor. The detection system 104 may generate an appropriate detection signal that is sent to the suppression system 102. The detection signal causes the suppression system 102 to actuate and release an appropriate hazard control material, such as a fire suppressant, into the enclosed volume 110 of the transportable container 100 to suppress, extinguish, or otherwise dispose of the hazard condition.

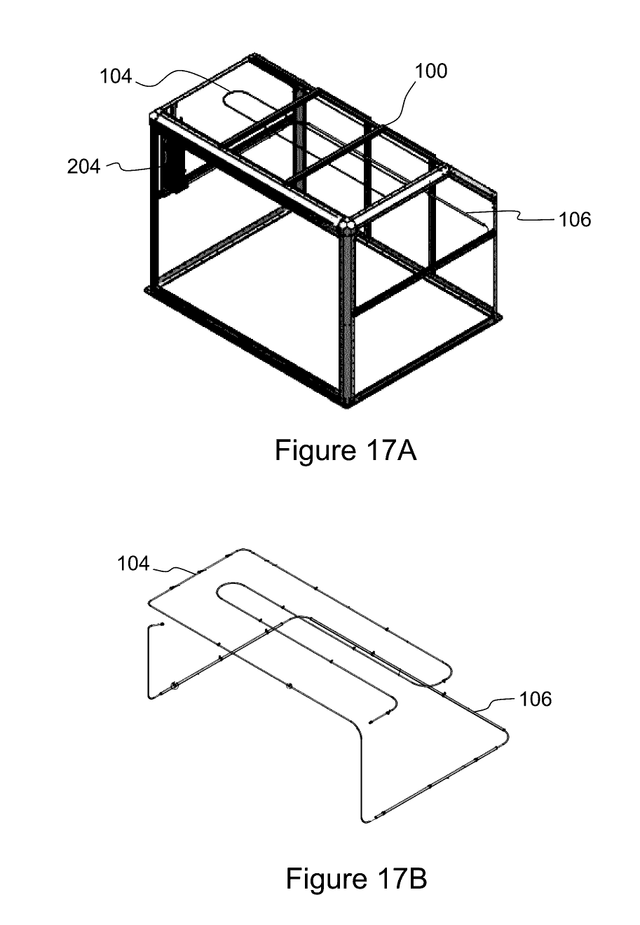

Referring now to FIGS. 1, 17A, and 17B, in one embodiment, the detection system 104 may be routed along one or more internal walls of the transportable container 100 such that the detection system 104 is exposed to any hazardous condition that may occur within an enclosed volume 110 of the transportable container 100. For example, the detection system 104 may be installed within the enclosed volume 110 of the transportable container 100 such that the detection system 104 is positioned along at least one wall or the ceiling of the transportable container 100. In one embodiment, the detection system 104 may be positioned along at least a portion of each fixed wall as well as the ceiling of the transportable container 100, to substantially encircle any cargo placed within the enclosed volume 110 of the transportable container 100.

Detection Tube

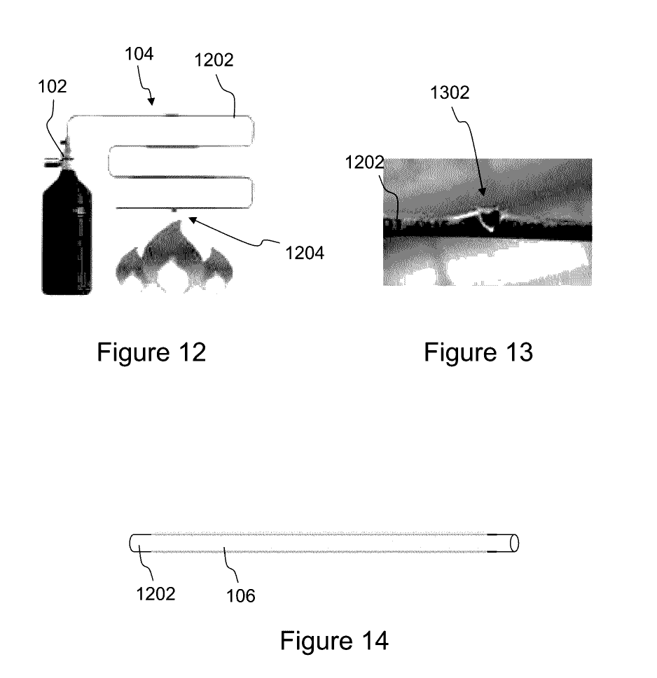

In a first embodiment, the detection signal may comprise a pneumatic signal generated in response to the detection of a fire inside of the transportable container 100. Referring now to FIGS. 12 and 13, the detection system 104 may comprise a detection tube 1202 configured to be held under a predetermined internal pressure until exposed to a trigger event such as exposure to flame, elevated ambient temperatures generally associated with a fire, or a particular energy level associated with a fire. Exposure of the detection tube 1202 to the trigger event may cause the structural integrity of the detection tube 1202 to degrade until the detection tube leaks, bursts, or otherwise loses internal pressure. For example, an opening 1302 in the detection tube 1202 may result from the degradation in structural integrity at a location 1204 where the flames of the fire come into contact with the detection tube 1202. The loss in pressure of the detection tube 1202 generates the detection signal that is used to actuate the suppression system 102.

The detection tube 1202 may comprise any appropriate materials that degrade when exposed to the trigger event, such as: Firetrace® detection tubing, aluminum, aluminum alloy, cement, ceramic, copper, copper alloy, composites, iron, iron alloy, nickel, nickel alloy, organic materials, polymer, titanium, titanium alloy, rubber, and the like. The detection tube 1202 may be formed to any appropriate shape or dimension and may further comprise a coating resist corrosion, deformation, fracture, or other damage unrelated to the trigger event.

The internal pressure that the detection tube 1202 is pressurized to may be determined by a temperature or energy level at which degradation of the tube is desired to occur. For example, the detection tube 1202 may comprise a material that degrades differently when subjected to various combinations of ambient temperature and internal pressure thereby allowing a user to select what conditions must be met by the trigger condition. The detection tube 1202 may demonstrate an inverse relationship between the internal pressure of the detection tube and the temperature that causes the detection tube to degrade, leak, and/or burst. For example, as the detection tube 1202 is pressurized to a higher level the detection tube 1202 may burst when exposed to a lower temperature. Alternatively, the detection tube 1202 may demonstrate a direct relationship between the internal pressure of the detection tube 1202 and the temperature that causes the detection tube 1202 to degrade, leak, burst, or otherwise lose internal pressure.

The detection tube 1302 may be pressurized with a higher or lower internal pressure than an ambient pressure in the enclosed volume 110 of the transportable container 100. The internal pressure of the detection tube 1202 may be achieved and sustained in any suitable manner, such as by pressurizing and sealing the detection tube 1202; connecting the detection tube 1202 to an independent pressure source such as a compressor or pressure bottle; or connecting the detection tube 1202 to a pressure vessel and using a portion of a pressurized fluid and/or gas within the pressure vessel to pressurize the detection tube. The detection tube 1202 may be pressurized with any fluid that is sensitive to changes in temperature or pressure. For example, a substantially inert fluid such as air, nitrogen, or argon may be used to pressurize the detection tube 1202 to a predetermined internal pressure.

The detection tube 1202 may also be configured to be sealed on each end while maintaining the predetermined internal pressure. The detection tube 1202 may be sealed by any suitable method. For example, referring now to FIG. 2, one end of the detection tube 1202 may be coupled to a deployment valve 202 and the other end may be sealed at a termination point (not shown). The termination point may also provide a location where the detection tube 1202 may be pressurized. The termination point may comprise any suitable method or device for sealing the pressure tube 1202, such as a plug, a pressure gauge, a schrader valve, or a presta valve.

The detection tube 1202 may be pressurized to a level substantially equivalent to a pressure of a pressure vessel 204 that holds the hazardous control material. Alternatively, the detection tube 1302 may be pressurized to a level higher than that of the pressure vessel 204, creating a pressure differential at the deployment valve 202 that may range between 50-600 pounds per square inch (psi). To reduce the potential for pressure leakage from the detection tube 1302 through the deployment valve 202 and into the pressure vessel 204, the detection tube 1202 may be configured with a one-way valve (not shown). The one-way valve may be suitably adapted to prevent the higher pressure in the detection tube 1202 from bleeding into the lower pressure side of the pressure vessel 204.

Referring now to FIGS. 1 and 14, the protective element 106 may be used to cover at least a portion of the detection tube 1202 to reduce a likelihood of damage to the detection tube 1202 which might result in an inadvertent actuation of the pneumatically actuated fire suppression system. The protective element 106 may comprise any suitable material capable of withstanding impacts, or resistance to being cut such as metal, composites, polymers, and the like. For example, a perforated metal tubing may be positioned over the detection tube 1202 to prevent accidental puncture of the detection tube by cargo boxes, sharp instruments, hand trucks, or any other objects which could damage the detection tube. Alternatively, the protective element 106 may be integrated into the sidewalls of the transportable container 100 and configured to provide a protected routing path for the detection system 104 through the enclosed volume 110.

Linear Detection System

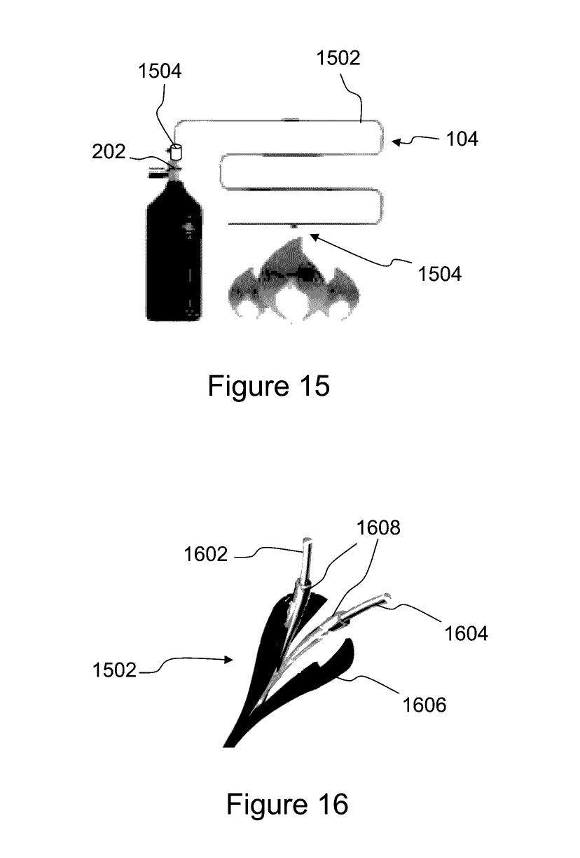

In a second embodiment, the detection signal may comprise an electric signal generated in response to the detection of a fire inside of the transportable container 100. Referring now to FIGS. 15 and 16, the detection system 104 may comprise a linear heat detector 1502 connected to a solenoid 1504 that is electrically coupled to the deployment valve 202. The linear heat detector 1502 may be suitably configured to be responsive to the trigger event. For example, the linear heat detector 1502 may comprise a first and second conductor wire 1602, 1604 wrapped together inside of a protective cover 1606. The first and second conductor wire 1602, 1604 may each be individually covered with a heat sensitive coating 1608 that is suitably adapted to melt or otherwise decompose when exposed to a pre-determined elevated temperature associated with the trigger event. The heat sensitive coating 1608 may comprise any appropriate materials that degrade when exposed to the trigger event, such as a temperature sensitive polymer. The temperature sensitive polymer may be selected according to any suitable criteria such as a desired temperature that causes the polymer to melt. In this manner, the detection system 104 may be configured to be responsive to more than a single operational temperature.

After the heat sensitive coating 1608 melts in response to the trigger event, the first and second conductor wire 1602, 1604 come into contact with each other and form a circuit. The circuit generates the detection signal and causes the solenoid 1504 to actuate the suppression system 102.

Any suitable source of electrical power may be used to power the linear heat detector 1502 connected and the solenoid 1504. For example, in one embodiment, a battery may be used to provide power. In an alternative embodiment, the detection system 104 may be configured to be selectively coupled to an external power source such as an electrical outlet or an onboard system such as an auxiliary power unit.

Suppression System

The suppression system 102 is suitably adapted to respond to the detection signal by releasing an appropriate hazard control material into the enclosed volume 110 to mitigate the detected hazard. The suppression system 102 may comprise any suitable device or components for affecting a hazard or suppressing a fire. For example, referring now to FIGS. 1, 2A, and 17A, in one embodiment, the suppression system 102 may comprise the pressure vessel 204 that is configured to be coupled to an internal wall or surface of the transportable container 100. The pressure vessel 204 may be coupled to the internal wall by any suitable method such as a harness, a bracket, or a cabinet. In one embodiment, the pressure vessel 204 may be configured to be installed substantially upright such that an inlet end of the pressure vessel 204 is positioned at the highest point of the pressure vessel 204 and allows the pressure vessel 204 to be located in a corner of the transportable container 100 between two adjacent interior walls. Referring now to FIG. 2B, in an alternative embodiment, the pressure vessel 204 may be configured to be installed in a horizontal manner to allow the pressure vessel 204 to be located in an upper corner of the transportable container 100 between an interior wall and a ceiling.

The pressure vessel 204 may also be coupled to the deployment valve 202, wherein the pressure vessel 204 is suitably configured to store the hazard control material. The suppression system 102 may be further coupled to a discharge system 206 and the detection system 104.

The pressure vessel 204 may comprise any suitable type of container or device for housing the hazard control material under pressure. The pressure vessel 204 may comprise any suitable system for storing and/or providing the hazard control material, such as a pressurized tank or bottle. The pressure vessel 204 may be suitably configured to contain a mass or volume of any suitable hazard control material such as a liquid, gas, or powder material. The pressure vessel 204 may also be configured to withstand various operating conditions including: temperature variations of up to 600 degrees Fahrenheit, vibration, impact, and environmental pressure changes. The pressure vessel 204 may be made of any suitable material, with the material selected according to any appropriate criteria, such as requirements to resist corrosion, deformation, fracture, and/or the like. The pressure vessel 204 may further comprise any suitable shape or dimension. For example, an internal volume of the pressure vessel 204 may be selected to hold a sufficient amount of hazard control material to effectively suppress or extinguish a fire condition that may occur within the interior volume 110 of the transportable container 100.

The pressure vessel 204 may also be suitably configured to hold the hazard control material under any suitable internal pressure. For example, in one embodiment, the pressure vessel 204 may hold or maintain the hazard control material at a pressure of up to about 360 psi. In a second embodiment, the pressure vessel 204 may be configured to hold the hazard control material at a pressure of up to about 800-850 psi.

The hazard control material may be selected according to the particular hazard and/or environment that the container 100 will be used in. For example, if the pneumatically actuated fire suppression system is configured to suppress a fire in the enclosed volume 110 by maintaining a low oxygen level, the control material may be selected from any suitable chemical or compound adapted to absorb or dilute oxygen levels when transmitted into the enclosed volume 110. As another example, if the pneumatically actuated fire suppression system is configured to suppress a fire by inhibiting the chemical reaction of the fire, the hazard control material may be selected from an appropriate agent. In yet another embodiment, the hazard control material may be selected from materials adapted to suppress a fire by reducing the heat of the fire.

For example, one hazard control material may comprise a fire suppressant suitably adapted for transient events such as explosions or other rapid combustion. Alternatively, the hazard control material may comprise a fire suppressant suitably adapted to change from a liquid state inside of the pressure vessel 204 to a gaseous state when ejected into the enclosed volume 110. The hazard control material may alternatively comprise a common dry chemical suppressant such as ABC, BC, or D dry powder. In another embodiment, the hazard control material may comprise a fire suppressant mixture such as potassium acetate and water. In yet another embodiment, the hazard control material may comprise a suppressant material further comprising additional chemicals or compounds such as various forms or combinations of lithium, sodium, potassium, chloride, graphite, acetylene, oxides, and magnetite.

The hazard control material may also be adapted to have more than a single method of controlling the hazard. For example, the hazard control material may comprise multiple elements or compounds, wherein each compound has a different property such as being reactive or unreactive to heat, acting to deprive a fire of oxygen, absorbing heat radiated from the fire, and/or transferring heat from the fire to another compound.

Valve

The deployment valve 202 provides a seal to the pressure vessel 204 allowing the hazard control material to be held within the pressure vessel 204 under pressure. The deployment valve 202 may comprise any suitable system for maintaining a pressurized volume of the hazard control material and for releasing that volume upon demand. For example, the deployment valve 202 may be actuated in response to the detection signal to allow the hazard control material to be released in the event that a hazard condition creates the trigger event. The deployment valve 202 may also comprise a fill system configured to allow the pressure vessel 204 to be pressurized after the deployment valve 202 is coupled to the pressure vessel 204.

The deployment valve 202 may be responsive to the detection signal from the detection system 104 and may be suitably adapted to actuate to open or otherwise remove the seal on the pressure vessel 204 in response to the detection signal. In one embodiment, once the deployment valve 202 actuates the entire volume of the control material may be released to the discharge system 206. In another embodiment, the deployment valve 202 may be suitably configured to control the rate of release of the hazard control material. For example, the deployment valve 202 may comprise a selectively activated opening such as a ball, piston, push, or gate valve that is configured to release a predetermined mass flow rate of fire suppressant material. The rate of release may be dependent on a given type of transportable container 100 or size of the enclosed volume 110 to be protected and may be related to the pressure within the pressure vessel 204 relative to the ambient pressure of the surrounding environment in the transportable container 100.

The deployment valve 202 may also be configured to release the hazard control material over a specific period of time. For example, the deployment valve 202 may be sized such that a total release of the hazard control material occurs over a period ranging from about twenty to sixty seconds. Alternatively, the deployment valve 202 may be suitably adapted to release the hazard control material over a relatively short period of time such as 0.1 seconds. The deployment valve 202 may also be configured to disperse a substantially constant level of hazard control material in a given volume.

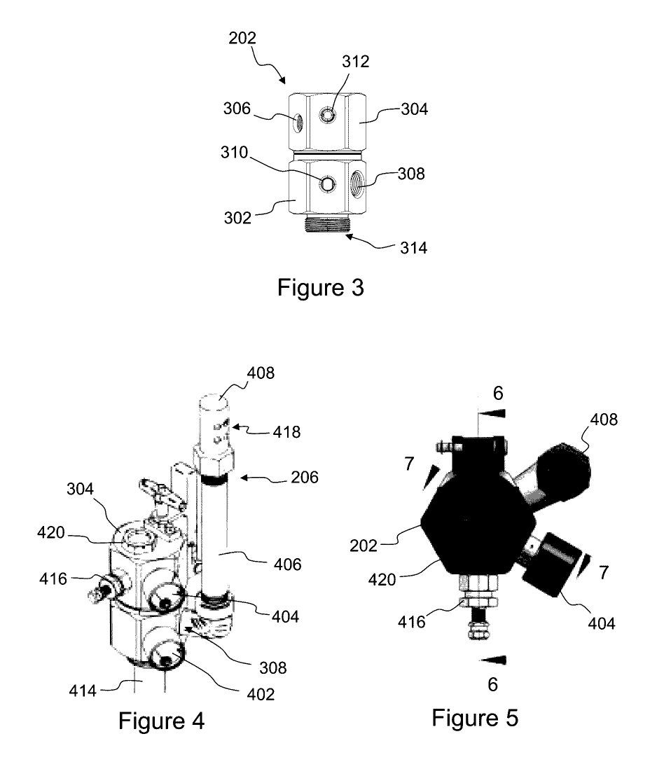

Referring to FIGS. 3-7, in one embodiment, the deployment valve 202 may comprise a multi-zoned valve having a valve body 302 coupled to a valve cap 304. The deployment valve 202 may further comprise a fill port 306 configured to couple to a fill valve 416, an inlet port 314 configured to couple to the pressure vessel 204, a discharge port 308 configured to couple to the discharge system 206, and a first and second pressure port 310, 312 configured to couple to a first and second pressure gauge 402, 404.

Valve Body

The valve body 302 may be coupled to the valve cap 304 by any suitable method such as mechanically, adhesively, welding, fusion, or the like. In one embodiment, the valve body 302 may comprise a set of threads 610 suitably configured to mate to a matching set of threads on the valve cap 304 to allow the two sections to be screwed together. One or more o-rings may be used to provide an enhanced seal between the threaded connection of the valve body 302 and the valve cap 304.

Internal Pressure Chamber

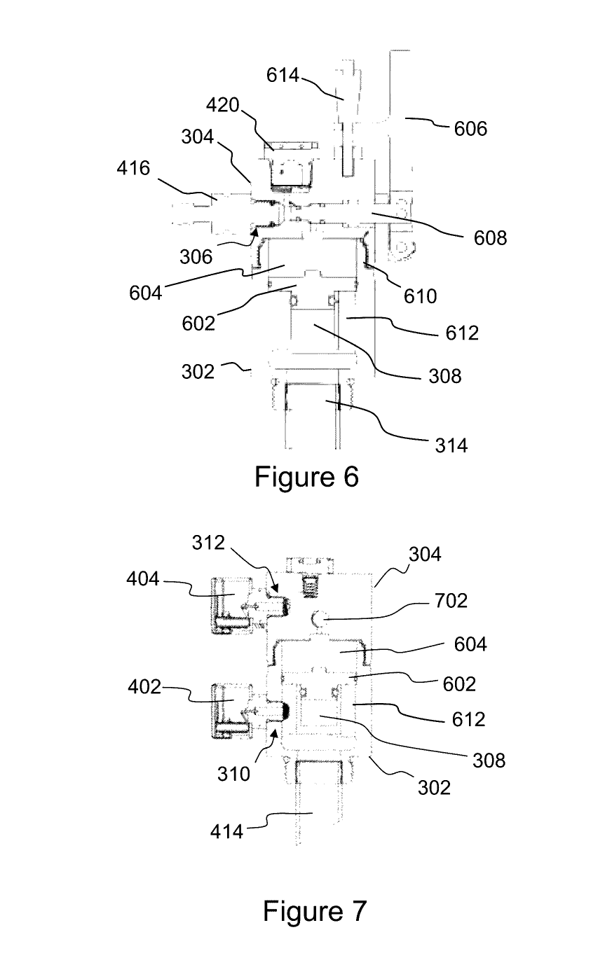

Referring now to FIGS. 6, 7, 8A, 9C, and 10, in one embodiment, the valve body 302 and the valve cap 304 may form an internal chamber 604 when coupled together. The internal chamber 604 may be open to the internal volume of the pressure vessel 204 when the deployment valve 202 is coupled to the pressure vessel 204 such that an air pressure in the internal chamber 604 is equal to the internal pressure of the pressure vessel 204. For example, the internal chamber 604 may be fluidly linked to the inside of the pressure vessel 204 by a side channel 612 that extends downwardly from the internal chamber 604 through the valve body 302 to the inlet port 314.

The discharge port 308 may be disposed in a mid-portion of the valve body 302 and be suitably configured to couple to the discharge system 206 to provide a path for the released hazard control material to exit the pressure vessel 204 and the deployment valve 202 when the deployment valve 202 is actuated in response to the detection signal. The discharge port 308 may comprise an opening of any suitable size or shape that extends outward from an inner portion of the deployment valve 202 through the valve body 302. The discharge port 308 may be configured to couple to the discharge system 206 by any suitable method. For example, a wall section of the discharge port 308 may comprise a set of recessed threads suitably configured to receive a set of matching threads on the discharge system 206 to allow the two sections to be screwed together.

Piston

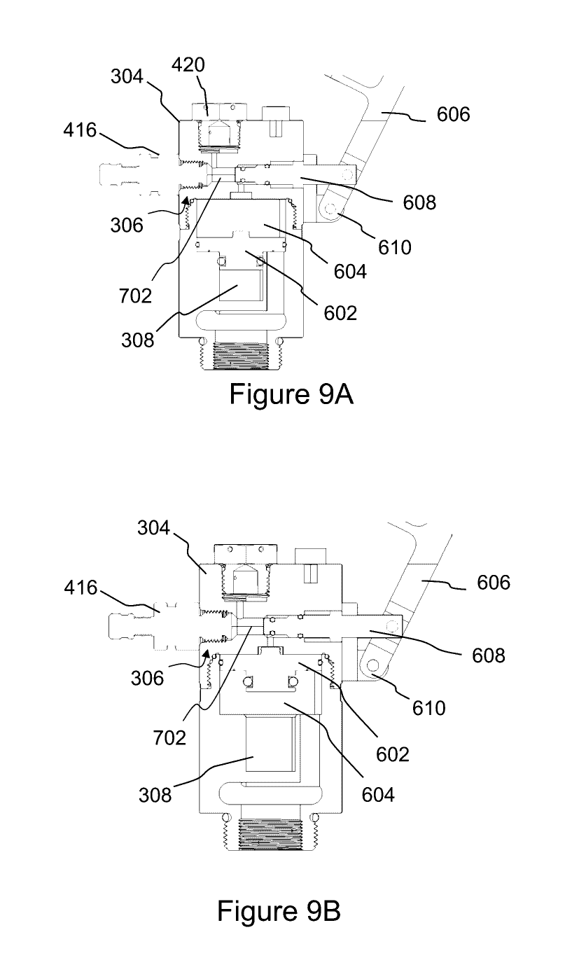

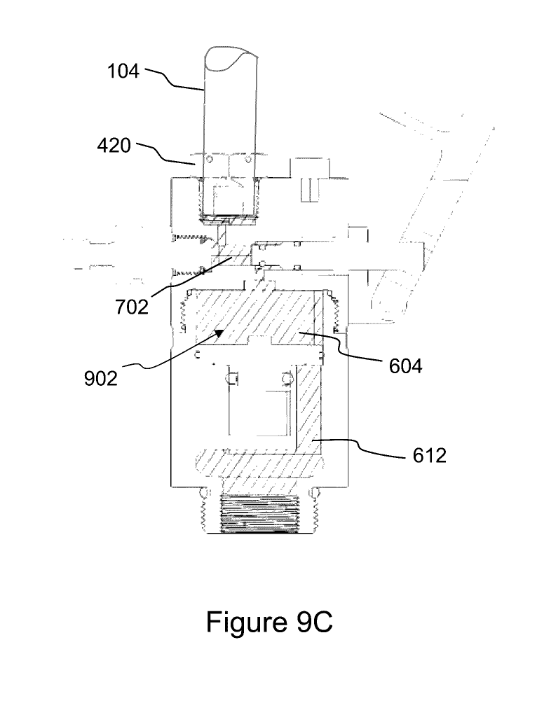

A piston 602 may be positioned within the internal chamber 604 and be configured to seal off the discharge port 308 from the internal chamber 604 and the side channel 612 when the deployment valve 202 is in an unactuated state. The piston may comprise any suitable device configured to move between a first position and a second position to selectively seal off the discharge port 308. Referring now to FIGS. 6-9A, in one embodiment the piston 602 may be configured to be positioned at a bottom portion of a cylinder such that it is seated against and seals off the discharge port 308. The piston 602 may be held against the discharge port 308 by any suitable method. For example, the piston 602 may be biased towards the discharge port 308 by a spring. Alternatively, the piston 602 may be sensitive to pressure differentials between the internal chamber 604 and the pressure vessel 204. For example, as the pressure vessel 204 is pressurized, the pressure in the internal chamber 604 may increase and force the piston 602 downwards against the discharge port 308. Referring now to FIG. 9B, a sudden pressure loss or reduction in the internal chamber 604 may act to cause the piston 602 to move upwards unsealing the discharge port 308 and creating a path for the hazard control material to escape the pressure vessel 204 and enter the discharge system 206.

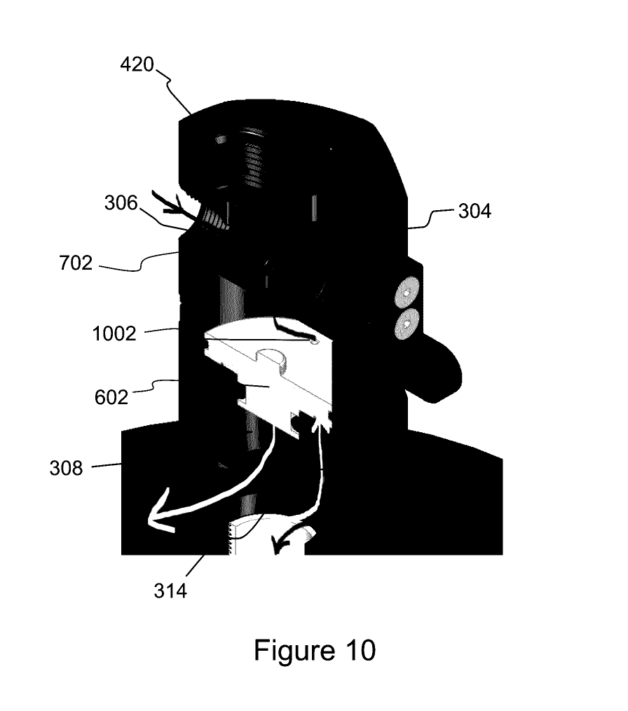

The piston 602 may be suitably configured to allow the pressure to equalize in the internal chamber 604 and the pressure vessel 204 and still allow for a pressure loss in the internal chamber 604 to cause the piston 602 to move upwards under force of the pressure in the pressure vessel 204. For example, referring now to FIG. 10, in one embodiment, the piston 602 may comprise a pressure hole 1002 or conduit that extends from a top surface of the piston 602 through a body of the piston 602 to a bottom surface of the piston 602 that is exposed to the side channel 612. Therefore, as the internal chamber 604 becomes pressurized, the pressure forces the piston 602 downward against the discharge port 308 while the pressure hole 1002 allows a portion of the pressure to pass through the piston 602 and into the pressure vessel 204 (shown by the dark line). Eventually, the pressures in the internal chamber 604 and the pressure vessel 204 will equalize. Due to the larger surface area on the top surface of the piston 602 exposed to the pressure in the internal chamber 604 relative to the surface area of the bottom surface of the piston exposed to the pressure in the pressure vessel 204, there is a net downward force acting on the piston 602 forcing it against the discharge port 308 which is exposed to an ambient pressure.

In the event of a sudden pressure loss in the internal chamber 604, the pressure force acting on the bottom surface of the piston 602 will become greater than the pressure force on the top surface of the piston 602 and the piston 602 will be forced upwards. The pressure hole 1002 may be sized such that the conduit path through the piston 602 is not large enough to allow the pressure from the pressure vessel 204 to escape through the piston 602 quick enough to overcome the overall pressure force acting on the bottom surface of the piston 602. As the piston moves upward unsealing the discharge port 308, the hazard control material may flow upward from the inlet port 314 through the side channel 612 and be directed into the discharge port 308 by the bottom surface of the piston 602 (shown by the white line). The hazard control material may then exit the deployment valve 202 and continue on to the discharge system 206 under the force of the pressure in the pressure vessel 204.

Referring now to FIGS. 3, 4, and 7, the first pressure port 310 may comprise an opening extending through the valve body 302 and into the internal chamber 604 to allow the first pressure gauge 402 to measure the pressure inside the internal chamber 604 and the pressure vessel 204. The first pressure gauge 402 may comprise any suitable system or device for measuring pressure and providing an indication of the measured pressure to a user. The first pressure gauge 402 may be coupled to the first pressure port 310 by any suitable method such as by being screwed into a threaded wall of the first pressure port 310.

Valve Cap

Referring now to FIGS. 3, 4, 6, and 7, the valve cap 304 helps seal off the internal chamber 604. The fill port 306 and the second pressure port 312 may be disposed in the valve cap 304 and be fluidly linked to the internal chamber 604. Similar to the first pressure port 310, the second pressure port 312 may comprise an opening extending from an exterior surface through the valve cap 304 to allow the second pressure gauge 404 to measure the pressure inside a fill channel 702. The second pressure gauge 404 may comprise any suitable system or device for measuring pressure and providing an indication of the measured pressure to a user. The second pressure gauge 404 may be coupled to the second pressure port 312 by any suitable method such as by being screwed into a threaded wall of the second pressure port 312.

Fill Port

Referring now to FIGS. 3, 4, 6, 8A, 9A, 9B, and 10, the fill port 306 may comprise a second opening extending from an exterior surface of the valve cap 304 to an inner portion of the valve cap 304 to engage the fill channel 702. A fill valve 416 may be coupled to the fill port 306 and be suitably configured to allow a source of air pressure to pressurize the internal chamber 604 and the pressure vessel 204. The fill valve 416 may comprise any suitable system or device for allowing air or any other similar fluid to be flowed into the internal chamber 604, such as a Schrader valve, a Presta valve, a quick connect one-way valve, or any other similar type of pneumatic fitting configured to prevent a fluid from flowing in an undesired direction.

Bleed Port/Inlet

The valve cap 304 may further comprise a bleed port 420 configured to allow the detection system 104 to be coupled to the deployment valve 202. The bleed port may comprise an opening extending through the valve cap 304 and may be comprise a plug or fitting configured to seal the valve cap 304 to prevent any leakage of pressure.

The bleed port 420 may also be configured to allow the pressure in the internal chamber 604 to be bled from the deployment valve 202 in a manner that prevents the piston 602 from moving upwards causing the actuation of the deployment valve 202 and the release of the hazard control material. For example, the bleed port 420 may comprise a fitting configured to allow a controlled release of pressure through the valve cap 304 that equals the rate at which pressure can move through the pressure hole 1002 such that the pressure forces acting on the top and bottom surfaces of the piston 602 do not differentiate sufficiently to cause the piston 602 to unseat and move upwards rapidly enough to cause the deployment valve 202 to actuate.

Fill Channel

In one embodiment, the bleed port 420 may be fluidly coupled to the fill channel 702 such that a pressure in the fill channel 702 may be equal to that of the detection tube 1202. The fill channel 702 may also provide a flow path for a fluid between the detection tube 1202 and the internal chamber 604. For example, referring now to FIGS. 9C and 10, the fill channel 702 may be configured to allow the fluid to be dispersed between the detection tube 1202, the fill channel 702, the internal chamber 604, the side channel 612, and the pressure vessel 204 such that the pressure (indicated by angled lines 902) is equal in each of the regions.

Due to the fluid link between the detection tube 1202 and the internal chamber 604, when the detection tube 1202 generates the detection signal resulting from a loss in pressure, the detection signal is detected in the internal chamber 604. For example, if a trigger event causes the detection tube 1202 to burst, the detection tube 1202 will depressurize. This loss in pressure will be translated through the bleed port 420, the fill channel 702, and into the internal chamber 604. Once the internal chamber 604 loses pressure, the piston 602 will move upwards and the deployment valve 202 will be actuated to release the hazard control material.

In an alternative embodiment, the fill channel 702 may be fluidly coupled to the solenoid 1504 through the bleed port 420 fill channel 702. When the linear heat detector 1502 responds to the trigger event the detection signal may be communicated to the solenoid 1504 causing it to open the bleed port 420 and release the pressure in the fill channel 702. The loss in pressure in the fill channel 702 will be translated to the internal chamber 604 causing a loss in the pressure to the internal chamber 604 which causes the piston 602 to move upwards actuating the deployment valve 202 to release the hazard control material into the enclosed volume 110.

Locking System

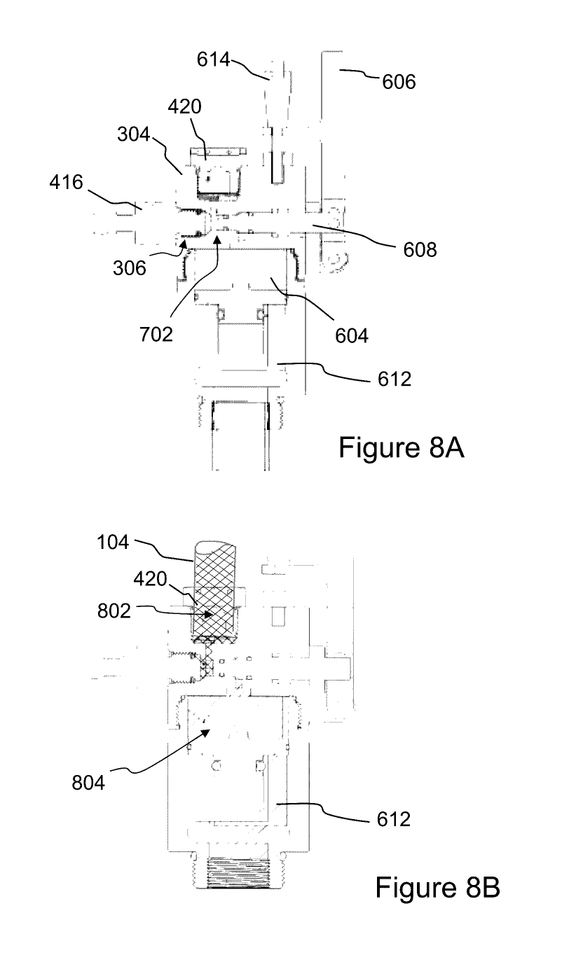

Referring now to FIGS. 8A, 8B, and 9A, the valve cap 304 may further comprise a disarm system configured to selectively prevent actuation of the deployment valve 202 of the pneumatically actuated fire suppression system such as during maintenance. The disarm system may comprise any suitable device or system for preventing movement of the piston 602 following a loss in pressure to the detection system 104. In one embodiment, the disarm system may comprise a push valve 608 suitably configured to plug or otherwise seal the fill channel 702 such that the fluid flow path between the bleed port 420 and the internal chamber 604 is blocked.

Push Valve

The push valve 608 may comprise a body configured to move or slide within the fill channel 702. For example, referring now to FIG. 9A, in an armed state, the push valve 608 may be positioned at an end of the fill channel 702 such that the flow path between the bleed port 420 and the internal chamber 604 is open. Referring now to FIGS. 8A and 8B, in a disarmed state, a first end of the push valve 608 may be inserted further into the fill channel 702 or otherwise repositioned to a disarmed position such that the flow path between the bleed port 420 and the internal chamber 604 is blocked.

When the push valve 608 is in the disarmed position, the pressure within the detection system 104 and the bleed port 420 (shown as cross-hatched lines 802) is separated from the pressure within the internal chamber (shown as angled lines 804). In the disarmed position, a pressure loss in the detection system 104 or the bleed port 420 will not be translated into the internal chamber 604 and the piston 602 will remain in place and the deployment valve 202 will not actuate. Positioning the push valve 608 in the disarm position allows the detection system 104 to be serviced or inspected after the pneumatically actuated fire suppression system has been installed without causing an inadvertent actuation of the deployment valve. This may increase both the overall safety of the pneumatically actuated fire suppression system for users and may also reduce costs associated with loss of hazard control material due to an accidental or inadvertent actuation of the deployment valve 202.

Lever/Pin

Referring now to FIGS. 6, 8A, 9A, and 9B, a second end of the push valve 608 may be coupled to a lever arm 606 configured to move the push valve 608 between the armed and disarmed positions. The lever arm 606 may comprise any suitable device or system for moving the push valve 608 between the armed and disarmed positions. For example, a body portion of the lever arm 606 may be linked to the push valve 608 and be configured to pivot about a joint such that the push valve 608 may be moved longitudinally within the fill channel 702. A handle may be positioned at a first end of the lever arm 606 to facilitate rotation of the lever arm 608 about the joint.

A locking pin 614 may be utilized to fix the position of the lever arm 606. For example, when the push valve 608 is positioned in the disarmed position, the locking pin 614 may be coupled to the lever arm 606 and the valve cap 304 to prevent the lever arm 606 from being moved. This may act as a security feature during service of the pneumatically actuated fire suppression system to provide a visual indication that the system is disarmed and the detection system 104 has been decoupled from the deployment valve 202.

Discharge System

The discharge system 206 is configured to deliver the control material to the enclosed volume 110 after it is released from the pressure vessel 204. The discharge system 206 may comprise any suitable system for delivering a control material such as a detection tube, a pipe, a duct, a perforated hose, a nozzle, or a sprayer. The discharge system 206 may comprise any suitable material such as metal, plastic, or polymer and may be suitably adapted to withstand elevated temperatures associated with fires or exposure to caustic chemicals.

For example, referring now to FIGS. 1, 2, and 4, the discharge system 206 may comprise a conduit path from the discharge port 308 to an elevated position within the enclosed volume 110. In one embodiment, the discharge system 206 may comprise a discharge tube 406 coupled on a first end to the discharge port 308 and a nozzle body 408 on a second end.

The nozzle body 408 may comprise any suitable device or system for dispersing the hazard control material into the enclosed volume. In one embodiment, the nozzle body 408 may comprise a series of ejector holes 418 arranged along a portion of the nozzle body 408 to separate the hazard control material into multiple streams directed towards one or more areas of the enclosed volume 110. For example, if the discharge system 206 is positioned in a corner of the enclosed volume 110, the ejector holes 418 may be arranged to disperse the hazard control material into a substantially ninety degree pattern such that the hazard control material is evenly dispersed into the enclosed volume 110.

The ejector holes 418 may comprise any suitable shape or size and may be determined according to any suitable criteria such as the type of hazard control material being used or the size of the enclosed volume 110. For example, if the transportable container 100 is longer along one side than another, there may be more ejector holes 418 facing the longer side or the ejector holes 418 may be larger to allow more of the hazard control material to be directed into the desired direction.

In another embodiment, the discharge system 206 may also be configured to act as the detection system 104. The discharge system 206 may also be pressurized or be configured to withstand pressures of up to 800 psi. For example, in one embodiment, the discharge system 206 may comprise the detection tube, wherein the detection tube is adapted to rupture or otherwise break in response to an applied heat load such as a fire. For example, rupturing of the detection tube may trigger the deployment valve 202 to release the control material. The released control material is then routed through the discharge system 206 to the location of the rupture where it exits and is dispersed into the transportable container 100.

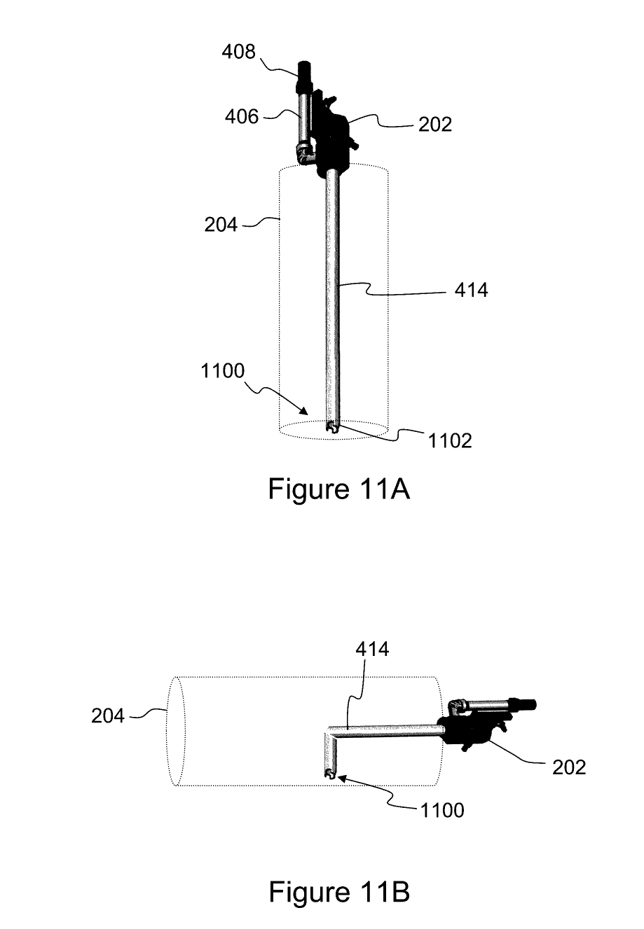

Referring now to FIGS. 4 and 11A, the pneumatically actuated fire suppression system may further comprise a siphon tube 414 extending downward from the deployment valve 202 and into the pressure vessel 204. The siphon tube 414 may be used to draw the hazard control material from the pressure vessel 204. The siphon tube 414 may extend into the pressure vessel 204 any suitable depth to receive the hazard control material. For example, if the hazard control material comprises a liquid and the pressure vessel 204 is installed in a substantially vertical position, then the siphon tube 414 may extend substantially all the way to the bottom of the pressure vessel 204 so that more of the hazard control material may be drawn into an inlet end 1100 when the deployment valve 202 is actuated. Alternatively, referring now to FIG. 11B, if the hazard control material comprises a liquid and the pressure vessel 204 is installed in a substantially horizontal position, then the siphon tube 414 may be bent in a downwardly fashion such that the inlet end 1100 of the siphon tube 414 is proximate a lowermost point of the pressure vessel 204.

Referring now to FIGS. 4, 11A, and 11B, The inlet end 1100 that may be suitably configured to allow an efficient flow of the hazard control material into the siphon tube 414. In one embodiment, the inlet end 1100 may comprise an opening that comprises a size or shape that is configured to reduce turbulent flow at the inlet end 1100. For example, the inlet end 1100 may comprise a three-notched opening 1102, wherein the notches are sized to allow for a smoother flow of hazard control material into the inlet end 1100. In a second embodiment, the inlet end 1100 of the siphon tube 414 may comprise an angled opening of between fifteen and forty-five degrees.

In operation, the pneumatically actuated fire suppression system is initially configured such that the detection system 104 monitors an enclosed volume 110 for the existence of a fire condition. For example, in the event of a fire condition inside the transportable container 100, the ambient temperature inside the transportable container 100 will increase at a rate determined by the intensity of the fire. Once the temperature reaches a predetermined threshold value, a detection tube may burst creating a detection signal that is sent to the suppression system 102 causing a fire suppressant to be released into the enclosed volume 110 of the transportable container 100.

These and other embodiments for methods of controlling a hazard may incorporate concepts, embodiments, and configurations as described with respect to embodiments of apparatus for controlling a hazard as described above. The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The technology has been described with reference to specific exemplary embodiments. Various modifications and changes, however, may be made without departing from the scope of the present technology. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present technology and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to a preferred embodiment. However, changes and modifications may be made to the preferred embodiment without departing from the scope of the present technology. These and other changes or modifications are intended to be included within the scope of the present technology, as expressed in the following claims.

1. A fire suppression system for a transportable unit load device having an enclosed volume, comprising:
a pressure vessel for containing a fire suppressant material, wherein the pressure vessel is configured to be coupled to an internal surface of the unit load device;
a deployment valve coupled to the pressure vessel and configured to controllably seal the pressure vessel under a first pressure, wherein the deployment valve comprises:
a valve body having an internal chamber open to an interior of the pressure vessel and the first pressure;
a valve cap having a fill channel fluidly coupled to the internal chamber, wherein the valve cap comprises a disarm system configured to seal the fill channel off from the internal chamber;
a discharge port disposed in the valve body;
a piston disposed within the internal chamber and configured to move between a first position and a second position in response to a pressure loss in the internal chamber, wherein the piston:
seals the discharge port from the internal chamber in the first position; and
unseals the discharge port from the internal chamber in the second position to allow the fire suppressant material to exit the pressure vessel through the discharge port under the first pressure; and
a detection system coupled the valve cap and configured to generate a detection signal in response to exposure to a fire condition, wherein the detection signal creates the loss in pressure in the internal chamber;
a discharge system coupled to the discharge port and positioned along an interior surface of the unit load device, wherein the discharge system is configured to eject the fire suppressant material into the enclosed volume of the unit load device.

2. A fire suppression system according to claim 1, wherein the valve cap further comprises:
a fill port linked to the fill channel; and
a push valve disposed within the fill channel and configured to:
be selectively moved between an armed position and disarmed position;
allow the fill port to pressurize the internal chamber and the pressure vessel when the push valve is in the armed position; and
seal off the fill channel from the internal chamber when the push valve is in the disarmed position.

3. A fire suppression system according to claim 2, wherein the valve cap further comprises a fill valve coupled to the fill port.

4. A fire suppression system according to claim 2, wherein the valve cap further comprises:
a lever arm configured to move the push valve between the armed position and the disarmed position; and
a locking pin configured to selectively lock the lever arm in place.

5. A fire suppression system according to claim 1, wherein the discharge system comprises:
a discharge tube connected to the discharge port on a first end; and
a nozzle body connected to a second end of the discharge tube, wherein:
the discharge tube is configured to route the released fire suppressant material to the nozzle body; and
the nozzle body is configured to eject the fire suppressant material into enclosed volume of the unit load device.

6. A fire suppression system according to claim 1, further comprising a siphon tube extending downward from a lower portion of the deployment valve and into the pressure vessel, wherein an inlet end of the siphon tube comprises a three-notched opening.

7. A fire suppression system according to claim 1, wherein the detection system comprises a detection tube coupled at a first end to the valve cap and sealed at a second end, wherein the detection tube is:
fluidly linked to the internal chamber through the fill channel;
routed along at least two interior surfaces of the unit load device; and
configured to rupture in response to exposure to a fire condition causing the pressure loss to the internal chamber.

8. A fire suppression system according to claim 7, wherein the valve cap further comprises a bleed port configured to couple the first end of the detection tube to the deployment valve.

9. A fire suppression system according to claim 7, wherein the deployment valve further comprises:
a first pressure gauge coupled to the valve body for detecting the first pressure; and
a second pressure gauge coupled to the valve cap for detecting a second pressure corresponding to the detection tube.

10. A fire suppression system according to claim 7, wherein the second end of the detection tube comprises a valve configured to allow the detection tube to be pressurized.

11. A fire suppression system according to claim 7, further comprising a protective covering configured to be positioned around at least a portion of the detection tube.

12. A fire suppression system according to claim 1, wherein the detection system comprises:
a solenoid coupled to the valve cap and fluidly linked to the fill channel;
a linear heat detector connected to the solenoid on a first end and routed along at least two interior surfaces of the unit load device, wherein the linear heat detector comprises:
a first conductor wire contained within a first heat sensitive coating; and
a second conductor wire contained within a second heat sensitive coating, wherein:
the first and second conductor wires are wrapped together inside of a protective cover;
first and second heat sensitive coatings are configured to degrade when exposed to the fire condition allowing the first and second conductor wires to come into contact with each and generate the detection signal.

13. A fire suppression system according to claim 12, wherein the solenoid is configured to open to cause a loss in pressure to the fill channel.

14. A fire suppression system according to claim 1, wherein the detection system comprises an infrared detector coupled to the valve cap and configured to generate the detection signal in response to detecting the fire condition.

15. A pneumatically actuated fire suppression system for a transportable unit load device, comprising:
a pressure vessel for containing a fire suppressant material at a first pressure;
a deployment valve coupled to the pressure vessel, wherein the valve comprises:
a valve body having an internal chamber open to an interior of the pressure vessel and configured to be held at the first pressure;
a piston disposed within the valve body and configured to move between a first position and a second position in response to a detected loss in pressure, wherein the piston:
covers a discharge port in the first position to hold the pressure vessel at the first pressure;
uncovers the discharge port in the second position to allow the release of the first pressure and the fire suppressant material to exit the pressure vessel through the discharge port; and
a valve cap coupled to an upper section of the valve body and configured to temporarily prevent the piston from moving from the first position to the second position;
a detection tube coupled at a first end to the valve cap and sealed at a second end, wherein the detection tube:
is fluidly linked to the internal chamber through the valve cap; and
configured to rupture when exposed to a fire condition causing the detected pressure loss; and
a discharge system coupled to the discharge port and configured to eject the released fire suppressant material into the unit load device.

16. A pneumatically actuated fire suppression system according to claim 15, wherein the detection tube comprises a heat sensitive pressure tube.

17. A pneumatically actuated fire suppression system according to claim 15, wherein the detection tube is disposed along at least one internal wall of the unit load device.

18. A pneumatically actuated fire suppression system according to claim 15, further comprising a perforated covering for the detection tube.

19. A pneumatically actuated fire suppression system according to claim 15, wherein:
the valve body further comprises a first pressure gauge for detecting the first pressure; and
the valve cap comprises a second pressure gauge for detecting a second pressure in the detection tube.

20. A pneumatically actuated fire suppression system according to claim 15, further comprising a siphon tube extending downward from a lower portion of the valve and into the pressure vessel, wherein an inlet end of the siphon tube comprises a three-notched opening.

21. A pneumatically actuated fire suppression system according to claim 15, wherein the valve cap further comprises:
a fill port; and
a push valve engaging the fill port and configured to:
be selectively moved between an armed position and disarmed position;
allow the fill port to pressurize the internal chamber and the pressure vessel when the push valve is in the armed position; and
seal the internal chamber to prevent the piston from moving from the first position to the second position when the push valve is in the disarmed position.

22. A pneumatically actuated fire suppression system according to claim 21, wherein the push valve seals off a fluid link between the detection tube and internal chamber when the push valve is in the disarmed position to prevent a pressure loss in the internal chamber from causing the piston to move from the first position to the second position.

23. A pneumatically actuated fire suppression system according to claim 21, wherein the valve cap further comprises a fill valve coupled to the fill port.

24. A pneumatically actuated fire suppression system according to claim 21, wherein the valve cap further comprises:
a lever arm configured to move the push valve between the armed position and the disarmed position; and
a locking pin configured to selectively lock the lever arm in place to maintain the push valve in the disarmed position.

25. A pneumatically actuated fire suppression system according to claim 21, wherein the valve cap further comprises a bleeder plug configured to:
couple the first end of the detection tube to the valve cap; and
depressurize the detection tube and the internal chamber when the push valve is in the disarmed position.

26. A pneumatically actuated valve for a pressure vessel, comprising:
a valve body having an internal chamber configured to be open to an interior of the pressure vessel, wherein the internal chamber is configured to be held at a same pressure as the pressure vessel;
a piston disposed within the valve body and configured to move between a first position and a second position in response to a detected loss in pressure within the internal chamber, wherein the piston:
covers a discharge port in the first position; and
uncovers the discharge port in the second position to allow the release of the pressure within the pressure vessel through the discharge port; and
a valve cap coupled to an upper section of the valve body and configured to temporarily prevent the piston from moving from the first position to the second position.

27. A pneumatically actuated valve according to claim 26, wherein the valve further comprises:
a fill port; and
a push valve engaging the fill port and configured to:
be selectively moved between an armed position and disarmed position;
allow the fill port to pressurize the first chamber, the second chamber, and the pressure vessel when the push valve is in the armed position; and
seal off the link between the first and second chambers when the push valve is in the disarmed position.

28. A pneumatically actuated valve according to claim 27, wherein the valve further comprises a fill valve coupled to the fill port.

29. A pneumatically actuated valve according to claim 27, wherein the valve further comprises:
a lever arm configured to move the push valve between the armed position and the disarmed position; and
a locking pin configured to selectively lock the lever arm in place to maintain the push valve in the disarmed position.

30. A pneumatically actuated valve according to claim 27, wherein the valve further comprises a bleeder plug configured to:
couple the first end of the pneumatic tube to the valve; and
depressurize the pneumatic tube and the second chamber when the push valve is in the disarmed position.
